(19) United States
(12) Patent Application Publication
(10) Pub. No.: US 2023/0394435 A1
(43) Pub. Date: Dec. 7, 2023

(54) SYSTEM AND METHODS FOR AUTOMATED MANAGEMENT OF CONSIGNMENT CYCLES

(71) Applicant: VASCODE TECHNOLOGIES LTD, Ramat Gan (IL)

(72) Inventors: Dorron MOTTES, Tel Aviv (IL); Caylee TALPERT, Tel Aviv (IL)

(73) Assignee: VASCODE TECHNOLOGIES LTD, Ramat Gan (IL)

(21) Appl. No.: 18/453,148

(22) Filed: Aug. 21, 2023

Related U.S. Application Data
(63) Continuation of application No. PCT/IB2022/051552, filed on Feb. 22, 2022.
(60) Provisional application No. 63/153,212, filed on Feb. 24, 2021.

(51) Int. Cl. G06Q 10/0875

(52) U.S. Cl. CPC G06Q 10/0875

(57) ABSTRACT

Systems and methods for automated management of a consignment cycle. A method includes: training a machine learning model using a training dataset, wherein the training dataset includes consignment transactions, wherein the machine learning model is trained to output proposed consignment allocations over a distribution chain; retrieving, from a first database, consignment scores and current consignment levels for consignees among the distribution chain; generating a proposed consignment allocation for each of the consignees by applying the machine learning model to features extracted from an electronic notice, the consignment scores, and the current consignment levels; generating a consignment allocation list based on the proposed consignment allocation; generating packing information based on the consignment allocation list; and printing packing slips for at least one first consignee of the consignees based on the packing information, wherein each first consignee has a consignment allocation according to the generated consignment allocation list.

### CROSS-REFERENCE TO RELATED APPLICATIONS

This application is a continuation of PCT Application No. PCT/162022/051552 filed on Feb. 22, 2022, now pending, which claims the benefit of US Provisional Patent Application No. 63,153,212 filed on Feb. 24, 2021.

The contents of the above-referenced applications are hereby incorporated by reference.

### TECHNICAL FIELD

The present disclosure generally relates to computer processes supporting distribution chains, and more specifically related to products through a chain of consignments.

### BACKGROUND

The distribution world is complex and faces many logistical challenges. One technique of delivering goods through a supply chain from a manufacturer to a consumer is using a process known as consignment. In a consignment, a consignor provides goods in consignment to a consignee against a promise to either pay or return the product within a predetermined period of time. At the end of the period, either a payment is made from the consignee to the consignor or the product is returned. In some cases, rollovers are possible, i.e., the period of consignment is extended, which may involve a changed cost of product to the consignee as a result of not meeting an agreed upon goal.

While existing solutions have attempted to address many aspects of consignment within the distribution chain, there still seem to be significant deficiencies that result in less than desirable results throughout the distribution chain. These solutions typically make use of accounting processes for movement of goods between entities, using agreements as the basis to define the transactional relationships. These deficiencies prevent each element in the distribution chain from operating optimally on both a local optimization as well as a global optimization. A particular deficiency is present with respect to consignment of products that involve the management of product transactions, payment transactions, placement of product, and redistribution of product. Moreover, while existing solutions primarily address the mechanics and logistics of the distribution challenge, those solutions fail to manage the risks associated with the management of the distribution channel both as a whole, i.e., globally, as well as on a more confined or local basis.

There is therefore a need in the art to provide solutions which overcome the deficiencies of the existing solutions in effective and efficient management of the consignment process.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for automated management of a consignment cycle. The method comprises: training a machine learning model using a training dataset, wherein the training dataset includes a plurality of consignment transactions, wherein the machine learning model is trained to output proposed consignment allocations over a distribution chain; receiving an electronic notice of goods available for consignment; retrieving, from a first database, consignment scores and current consignment levels for a plurality of consignees among the distribution chain; generating a proposed consignment allocation for each of the plurality of consignees by applying the machine learning model to features extracted from the electronic notice, the consignment scores, and the current consignment levels; generating a consignment allocation list based on the proposed consignment allocation; generating packing information based on the consignment allocation list; and printing packing slips for at least one first consignee of the plurality of consignees based on the packing information, wherein each of the at least one first consignee has a consignment allocation according to the generated consignment allocation list.

Certain embodiments disclosed herein also include a non-transitory computer readable medium having stored thereon causing a processing circuitry to execute a process, the process comprising: training a machine learning model using a training dataset, wherein the training dataset includes a plurality of consignment transactions, wherein the machine learning model is trained to output proposed consignment allocations over a distribution chain; receiving an electronic notice of goods available for consignment; retrieving, from a first database, consignment scores and current consignment levels for a plurality of consignees among the distribution chain; generating a proposed consignment allocation for each of the plurality of consignees by applying the machine learning model to features extracted from the electronic notice, the consignment scores, and the current consignment levels; generating a consignment allocation list based on the proposed consignment allocation; generating packing information based on the consignment allocation list; and printing packing slips for at least one first consignee of the plurality of consignees based on the packing information, wherein each of the at least one first consignee has a consignment allocation according to the generated consignment allocation list.

Certain embodiments disclosed herein also include a system for [to be completed based on final claims]. The system comprises: a processing circuitry; and a memory, the memory containing instructions that, when executed by the processing circuitry, configure the system to: train a machine learning model using a training dataset, wherein the training dataset includes a plurality of consignment transactions, wherein the machine learning model is trained to output proposed consignment allocations over a distribution chain; receive an electronic notice of goods available for consignment; retrieve, from a first database, consignment scores and current consignment levels for a plurality of consignees among the distribution chain; generate a proposed consignment allocation for each of the plurality of consignees by applying the machine learning model to features extracted from the electronic notice, the consignment scores, and the current consignment levels; generate a consignment allocation list based on the proposed consignment allocation; generate packing information based on the consignment allocation list; and print packing slips for at least one first consignee of the plurality of consignees based on the packing information, wherein each of the at least one first consignee has a consignment allocation according to the generated consignment allocation list.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic drawing of a system for management of a consignment chain according to an embodiment;

FIG. 2 is a block diagram of a consignment server of the system for management of a consignment chain according to an embodiment;

FIG. 3 is a flowchart of a method of operation of the consignment server according to an embodiment; and

FIG. 4 is a diagram of a goods distribution chain that may take advantage of the consignment server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several view.

U.S. patent application Ser. No. 11/457,045, publication number 2007/0016462, entitled “System and Process for Distributing Products” (hereinafter the '045 patent application) acknowledges that “there exists a need for improved distribution processes, and in particular, improved consignment distribution systems.” To resolve this matter, the '045 patent application suggests a system where “existence of authenticated transactions can be used to reliably determine changes in ownership of a product and to determine the appropriate financial settlement for parties participating in the distribution of the product” resolves certain consignment chain challenges. However, the '045 patent application fails to remedy the many deficiencies identified above and remains in the realm of solving a logistics problem. Various embodiments described herein provide solutions that remedy these deficiencies.

Products may be delivered from a manufacturer to a consumer through a complex distribution network. With multiple intermediaries in the way it is necessary to provide effective ways of management in particular in the case where management of consignment of goods is necessary. Accordingly, the system and methods thereof receive from a first server a notice of goods available for consignment and then retrieve from a database consignment scores and current consignment levels for potential consignees. Based on that it prepares a proposed consignment allocation that optimizes the distribution of goods through the distribution network after ensuring that the proposed allocation is guaranteeably. By doing that the risk of the consignors and consignees is reduced while providing real-time solutions otherwise not possible.

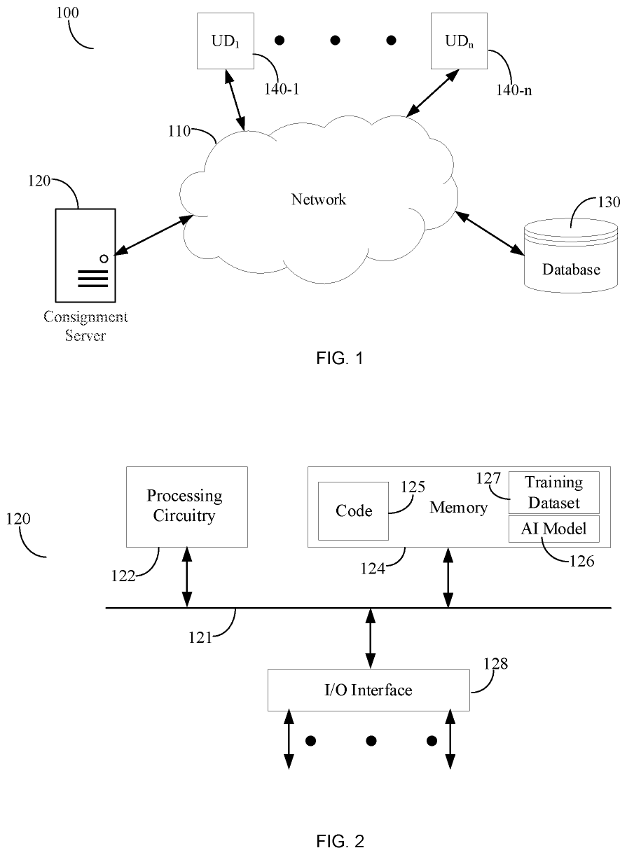

Reference is now made to FIG. 1 that depicts an example schematic drawing of a system 100 for management of a consignment chain according to an embodiment. The system 100 comprises a network 110 that communicatively connects components of the system 100 as described herein. The network may include one or more networks that are local area networks (LANs), wide-area networks (WANs), metro-area networks (MAN), the Internet, the worldwide web (WWW), and like networks in any combination. The network may be wired networks (Ethernet, fiber-optics, etc.) or wireless networks (WiFi®, cellular, etc.) in any combination.

A consignment server (CS) 120 is communicatively connected to the network 110 and is adapted to perform the functions described herein in greater detail. A database (DB) 130 is further communicatively connected to the network 110 to provide database functions such as, but not limited to, Structure Query Language (SQL) functions, data storage and retrieval functions, and the like, operating under the controls of CS 120, and as further explained herein.

Users of the system 100 may have respective user devices (UD) 140, for example UD 140-1 through UD-140-n, where ‘n’ is an integer greater than ‘1’, to communicatively connected to the network 140 and thereby operate the consignment processes described herein. UDs 140 include, but are not limited to, personal computers (PCs), notebook computers, tablets, cell phones, terminals and other like devices that allow for taking advantage of the benefits of system 100 as described in greater detail herein. Each UD 140 may, according to at least certain instructions provided by the CS 120, provide a user interface (UI) that is displayable on a display of (or associated with) the UD 140. Using the UI, a user of a UD 140 may interact, i.e., provide inputs and receive outputs, that are under the control of CS 120.

FIG. 2 shows an example block diagram of the CS 120 for management of a consignment chain according to an embodiment.

In a business environment where consignment is made available, the consignment process may be hierarchical. There may be a consignor, the body providing product to be consigned, and a consignee, a body receiving products that is consigned to it. Certain business terms may be attached to the consignment of these goods. For example, but not by way of limitation, these terms may include the cost per unit sold, the time by which payment is due from the consignee to the consignor, certain benefits for reaching desired goals, and so on.

As described herein, the CS 120 is configured to perform the consignment management process by receiving data, processing it, and distributing the data in meaningful ways that optimize the consignment process. Such optimization includes the proper distribution of consignable goods through the consignment chain, management of the consigned goods within the consignment chain, management of benefits based on analysis and more. For these purposes, and as further explained herein, the CS 120 includes a processing circuitry 122, a memory 124, and an input/output (I/O) interface 128.

The memory 124 may combine both volatile (e.g., random access memory) and non-volatile memory (e.g., Flash, read-only memory, etc.). A section of the memory 124 may contain code 125. The code 125 includes instructions that may be executed by the processing circuitry 122. When executed by the processing circuitry 122, the code configures the CS 120 to perform the methods of optimized consignment provided herein. In addition, the memory 124 may contain a training set 127 and an artificial intelligence (AI) model 126.

The AI model 126 may be trained as described herein using the training set 127. The training is performed in order to ensure proper operation of the AI model 126 when operated by the processing circuitry 122 when executing the code 125 for the purposes of analyzing certain aspects of the consignment management according to the disclosed embodiments. The processing circuitry 122, memory 124 and I/O interface 128 are communicatively connected, for example, but not by way of limitation, by a bus 121. A person having ordinary skill in the art would readily appreciate that the AI model 126 may be a model of artificial neural network learning methods without departing from the scope of the disclosure.

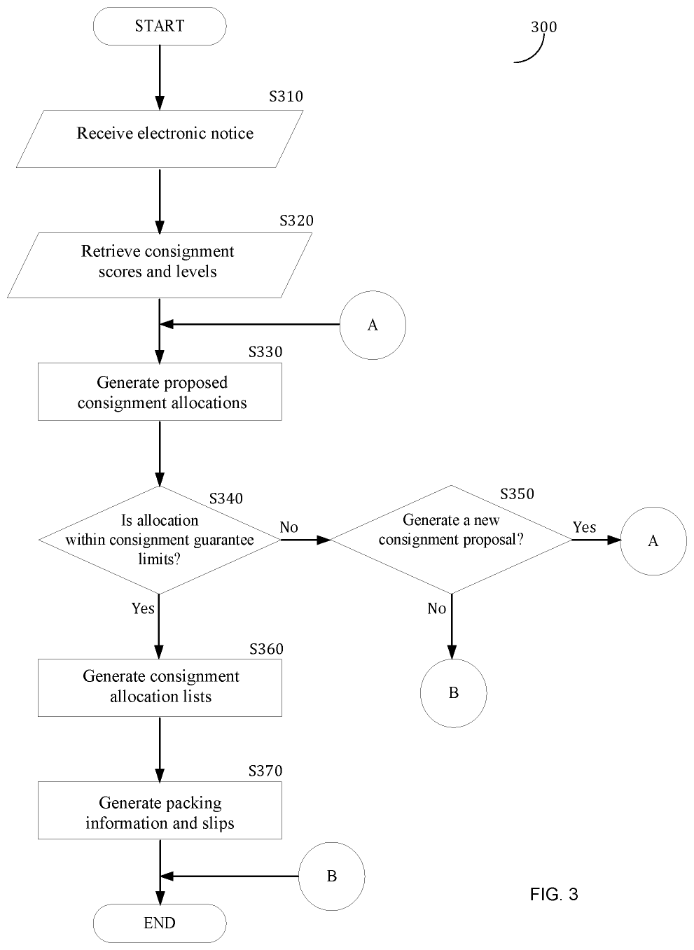

FIG. 3 is an example flowchart 300 illustrating a method for automated management of a consignment cycle according to an embodiment. In an embodiment, the method is performed by the consignment server 120, FIG. 1.

At S310, a notice is electronically received. The notice includes information of goods available for consignment such as, but not limited to, quantities of goods for consignment, prices, terms and conditions of consignments, and the like. Such a notice may be received by consignment server 120 from a user device 140 communicatively connected to the consignment server 120 through the network 110. The notice is provided from a consigner of goods operating the user device 140 using a variety of interfaces that are communicatively connected to the user device 140, including but not limited to, physical keyboard, virtual keyboard, image capture, audio capture, and the like.

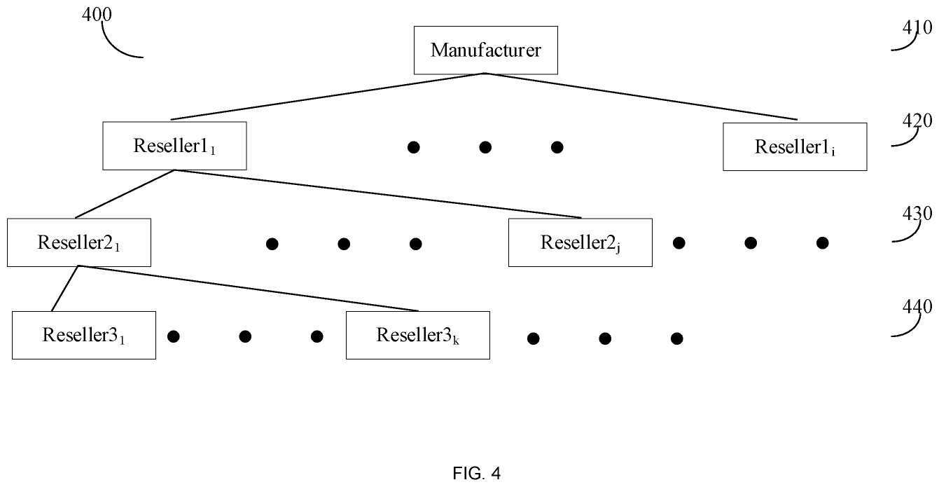

As discussed below with respect to FIG. 4, the consigner of goods may be a manufacturer, a reseller, a wholesaler, or any other entity that may have authority to manage a consignment process. The user device 140 may be operated by a commerce manager of a particular level within the distribution chain, as described in FIG. 4, and that further explains the hierarchical nature that makes the solving of the consignment challenge one that requires a technical solution as described herein.

At S320, consignee information as well as respective consignment information is retrieved from a database. Consignee information may include, but is not limited to, the name of the consignee, consignee's location, and the like. Consignment information for a specific consignee may include, but is not limited to, consignment scores, current consignment levels of consignees, annual sales, year-to-date sales, past promotions and performance, and the like.

At S330, a consignment allocation is generated based on the received notice (at S310) and the data retrieved from the database (at S320). In an embodiment, the consignment allocation is generated by feeding features extracted from the received notice and the retrieved data to the AI model 126 that is executed by the processing circuitry 122 subsequent to an initial training of the AI model 128. Such training of the AI model 126 ensures that the AI model 126 performs well, i.e., by providing the optimized consignment plan over the distribution chain (see for example FIG. 4). To this end, in a further embodiment, the AI model 126 may be updated using feedback. Moreover, as described further herein below, the AI model 126 may be continually updated using updated training sets as the distribution chain changes, thereby improving the performance of the AI model 126.

It should be understood that the distribution chain is dynamic such that there may be additions and omissions from the distribution chain, changes in performance over time, environmental changes, and the like. These changes may impact future performance. It is therefore essential to provide a training dataset 127 that can be used to train the AI model 126 in order to achieve its desired performance. While the allocation is described with respect to execution of an AI model 126, it should be appreciated that other techniques may be used, for example, the application of rules and using a rule engine (not shown) instead of or in combination with the AI model 126.

In an embodiment, the allocation generated at S330 is provided per the request of a single commerce manager at a particular level of the distribution chain (see FIG. 4 for an example of such levels). In another embodiment, the consignment server 120 may be configured to provide the consignment allocations for one or more levels of the distribution chain without departing from the scope of the disclosure.

At S340, it is checked whether the generated allocation can be guaranteed and, if so, execution continues with S360; otherwise, execution continues with S350.

The guarantee is an aspect of the solution that allows the system to check if a guarantor may issue a guarantee to each of the consignment allocation plans generated at S330. This serves to reduce overall risk and therefore keep costs under control. It becomes a significant challenge to handle such guarantees when there are multiple tiers in the hierarchy of the distribution chain, with each reseller in the distribution chain (see also FIG. 4) having a different risk profile that may be affected by a variety of factors including, but not limited to, location, time of year, other consignees around the location, changes in weather patterns (predicted or otherwise), and many other factors.

In an embodiment, the system, and in particular the AI model 128, may be adapted to evaluate the risk based on an ongoing learning process, thereby allocating and reallocating consignment of goods in a way that increases revenue, reduces risks, and allows for manageable distribution of the goods throughout the distribution network.

At S350, it is checked whether a new consignment plan is to be generated and if so, execution continues with S330; otherwise, execution terminates.

At S360, consignment allocation lists are generated based on the consignment plan. The generated consignment allocation lists may include, but are not limited to, information for each consignee, the amount of goods to be consigned, quantity of goods to be returned (if any), consignment schedule (e.g., how many days the consignment is in effect before goods are to be returned), and the like.

At S370, packing lists (e.g., for shipment) as well as for information for consignment managers handling a user device 140 that receive the packing lists are generated such that the consignment managers may expect the packages to be received and then to be distributed therefrom. In an embodiment, the packing lists may be of resellers at a lower level of the hierarchy (see also FIG. 4). As may be necessary, such packing slips may be printed for placement of the packages.

FIG. 4 is an example diagram 400 of a goods distribution chain that may take advantage of the consignment server according to an embodiment. At the top of hierarchy is, for example, the manufacturer 410 of the goods to be distributed for consignment. One of familiarity with the distribution chain would appreciate that in some cases, for example, an exclusive national distribution company may be at the top of the distribution hierarchy.

In another embodiment, the root company at the highest hierarchy level 410 may be a wholesale company. In yet another embodiment, the root company may be a reseller. The resellers may have hierarchies, that is, reseller at level 420, for example reseller 420-1, may resell to resellers at a lower level of hierarchy, for example resellers at level 430, for example reseller 430-1, and in turn that reseller 430-1 may sell to a reseller at a hierarchy level 440, for example to reseller 440-1, and so on and so forth.

As consignment of goods filters through the hierarchy of the distribution chain, there are more resellers to handle, more consignments to manager, and hence the need to effectively control the transfer of goods and application of the terms of consignment, as well as guarantees thereto. It should be appreciated that determining an optimal consignment plan that takes into account the various parameters, as discussed herein, cannot be performed manually and that the disclosed embodiments provide particular solutions that allow for determining optimal consignment plans automatically.

According to various embodiments, the created consignment plan may be used by each reseller independently of the others as goods trickle down or, alternatively, spanning over two or more hierarchical levels to further reap the possible optimization advantages, that is, to provide global optimization across the distribution chain rather than only local optimizations. While a hierarchy composed of a manufacturer (410) and resellers (420, 430 and 440) are shown in FIG. 4, one of ordinary skill in the art would readily appreciate that the like of a wholesaler, retailers, micro-retailer, or other entities that may have authority to manage a consignment process may also make use of a user device 140 for the purposes discussed herein. Each consigner may be a consignee but for the lowest level in the hierarchy where the goods are sold to an end-user.

The data collected electronically from each of the levels of resellers is used initially as a training set, for example as the training set 127. The training set may contain information regarding sales, returns, charges and payments, as well as dates of receipt and sale. The distribution chain based on which the training set is created and used to train the machine learning model is dynamic such that the components of the distribution chain, the connections between such components, or both, may change over time. As non-limiting examples of changes to the distribution chain, resellers may change levels, cease operation, relocate to other geographic areas, or expand their business reach to include additional areas.

By continuously collecting the data from the resellers systems and updating the training set, an improved AI model such as the AI model 126 is generated. The improved AI model is then used to generate new and better consignment plans which allow the system to be more efficient, i.e., to handle more transactions as well as providing better accuracy. This better accuracy may further have beneficial effects related to providing consignment plans that better fit market needs.

Moreover, as the AI model changes over time through iterative training with updated training sets, the AI model becomes capable of responding to actual changes in the marketplace that otherwise would have required an extended period before manifesting as detectable characteristics up the chain. These changes may have a significant cost and performance impact that can be avoided due to the iterative training of the AI model.

The AI model may be further adapted through the training dataset to optimize the consignment period. That is, the consignment period may be optimized to allow sufficient time for consignment but not overly long, thereby creating a balance in the supply chain. For example, if the consignment periods are too long, then many goods may be in transition at a single time, thereby creating a need to manufacture and deliver more product before actually generating revenue. On the other hand, if the period of consignment is too short, then product may be returned unnecessarily and prematurely. Both cases result in heavy load on the system 100, and particularly on the consignment server 120.

By using the AI model, complex patterns that change over time are recognized, thereby allowing for reduction of the load on the consignment server 120 while providing an improvement in overall performance of the system 100. Buying patterns are therefore analyzed as described herein, and comparisons are thereafter performed between the various products, various warehouses, and various regions. Furthermore, additional data provided in the dataset may include, but is not limited to, routing information using global system positioning (GPS), driving routes, changes in delivery patters, blockage of certain areas (e.g., due to flood, riots, earthquakes, etc.), and more. All of this data, continuously updated through updated training sets, provides fora dynamic AI model that is responsive to changes in near-real-time.

The AI model may be further used to analyze and recommend products based on sets constraint to generate an appropriate product bundle, where a bundle is a combination of different products that are provided to a reseller together at a predetermined price level. Using the AI model, it is possible to create new bundles based on analysis of the data as well as to retrain the AI model to adapt to new data as markets, resellers, and consumers change.

In an embodiment, the AI model may be trained to identify profiles of resellers based on data and parameters and to define relevant bundles otherwise practically impossible to conceive due to the large number of possibilities that are beyond human reach. The AI model may further create bundles based on the time a retailer is on system, a number of orders, and other relevant parameters. In an embodiment, the AI model may be utilized to determine whether to expand or otherwise extend credit based on consignment repayment and the time to repay.

In yet another embodiment, the AI model may be trained to identify “flooding” of markets with products as the resellers chain gets filled with products. When such flooding is identified, it can be determined consignment for those specific resellers in the chain should cease in order to achieve a better balance throughout the chain. Based on analysis of resellers' portfolios and status, the AI model can be utilized to identify the state of market, at each level and order the right products, or set restrictions on the cases that can be distributed (e.g., in the case of a “flooded” market).

According to various embodiments disclosed herein, the generation of a proposed consignment may be updated to accommodate for various interaction at each level of the hierarchy. Therefore, inputs from a consignee (e.g., Reseller21 at hierarchy level 430) are handled (e.g., at S330, FIG. 3) in order to provide the consignor of Reseller21 (e.g., Reseller11 at hierarchy level 420) and that consigns goods to Reseller21, the necessary recommendations with respect for its consignees (e.g., Reseller21). These may include, but are not limited to, the level of consignment of goods for the consignee based on past performance and predicted future performance, levels of permitted rollovers (none, full or partial), pricing adjustments, discounts, and levies that may all impact the overall performance of the entire distribution chain.

By providing a learning system, as shown for example with respect of the use of the AI model 126, a technical solution is provided with levels of optimizations that otherwise cannot be reached in a deep and widespread distribution channel is shown herein. Moreover, the system 120 further provides, based on its learning capabilities, the level of risk that can be guaranteed with respect of the entire distribution chain that provides an overall optimization that may cross the entire distribution chain.

A person having skill in the art would appreciate that rollover is an example of an extension. A rollover may be necessary when a consignee who pays the amounts for the consignment (in full or partial) and that amount immediately is used to pay for the consignment (in full or partial) and then the entire consignment automatically rollovers for an additional period (e.g., two weeks). In an embodiment, this consignment rollover is limited such that consignment is performed no more than a predetermined number of times during the period. This can be done either by heuristics or by the AI model 126 through its learning capabilities of the entire distribution chain in an aim to optimize overall results. Even when only partial payment is made against the consignment amount, the AI model 126, when executed by the PU 122, may identify the particular consignee as a worthy customer and take this into consideration. For example, it may allow for rolling over the consignment for this partial payment for an additional period of time.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for automated management of a consignment cycle, comprising:
training a machine learning model using a training dataset, wherein the training dataset includes a plurality of consignment transactions, wherein the machine learning model is trained to output proposed consignment allocations over a distribution chain;
receiving an electronic notice of goods available for consignment;
retrieving, from a first database, consignment scores and current consignment levels for a plurality of consignees among the distribution chain;
generating a proposed consignment allocation for each of the plurality of consignees by applying the machine learning model to features extracted from the electronic notice, the consignment scores, and the current consignment levels;
generating a consignment allocation list based on the proposed consignment allocation;
generating packing information based on the consignment allocation list; and
printing packing slips for at least one first consignee of the plurality of consignees based on the packing information, wherein each of the at least one first consignee has a consignment allocation according to the generated consignment allocation list.

2. The method of claim 1, wherein the training dataset is continuously updated based on changes to the distribution chain, wherein the machine learning model is iteratively trained using the training dataset at a plurality of times.

3. The method of claim 2, wherein the changes to the distribution chain include at least one of: changes in components of the distribution chain, and changes to connections between the components of the distribution chain.

4. The method of claim 1, wherein the machine learning model is further trained to optimize a consignment period of the proposed consignment allocation.

5. The method of claim 1, wherein the proposed consignment allocation is at least partially influenced by a predetermined scoring tier of each consignee of the plurality of consignees.

6. The method of claim 1, further comprising:
determining that the proposed consignment allocation can be guaranteed based on consignment data of the plurality of consignees.

7. The method of claim 6, wherein determining that the proposed allocation can be guaranteed further comprises:
determining whether the at least one first consignee of the plurality of consignees has consumed a consignment within a predetermined period of time.

8. The method of claim 7, further comprising:
generating an electronic notice of demand to each consignee of the plurality of consignees who has not consumed a consignment within a predetermined period of time.

9. The method of claim 1, wherein generating the proposed consignment allocation further comprises:
determining a permissible rollover of consignment goods.

10. A non-transitory computer readable medium having stored thereon instructions for causing a processing circuitry to execute a process, the process comprising:
training a machine learning model using a training dataset, wherein the training dataset includes a plurality of consignment transactions, wherein the machine learning model is trained to output proposed consignment allocations over a distribution chain; receiving an electronic notice of goods available for consignment;
retrieving, from a first database, consignment scores and current consignment levels for a plurality of consignees among the distribution chain;
generating a proposed consignment allocation for each of the plurality of consignees by applying the machine learning model to features extracted from the electronic notice, the consignment scores, and the current consignment levels;
generating a consignment allocation list based on the proposed consignment allocation;
generating packing information based on the consignment allocation list; and
printing packing slips for at least one first consignee of the plurality of consignees based on the packing information, wherein each of the at least one first consignee has a consignment allocation according to the generated consignment allocation list.

11. A consignment server for automated management of a consignment cycle of goods comprising:
a processing circuitry;
an input/output interface communicatively connected to the processing circuitry; and
a memory communicatively connected to the processing circuitry, the memory containing code that, when executed by the processing, circuitry, configures the consignment server to:
train a machine learning model using a training dataset, wherein the training dataset includes a plurality of consignment transactions, wherein the machine learning model is trained to output proposed consignment allocations over a distribution chain; receiving an electronic notice of goods available for consignment;
retrieve, from a first database, consignment scores and current consignment levels for a plurality of consignees among the distribution chain;
generate a proposed consignment allocation for each of the plurality of consignees by applying the machine learning model to features extracted from the electronic notice, the consignment scores, and the current consignment levels;
generate a consignment allocation list based on the proposed consignment allocation;
generate packing information based on the consignment allocation list; and
print packing slips for at least one first consignee of the plurality of consignees based on the packing information, wherein each of the at least one first consignee has a consignment allocation according to the generated consignment allocation list.

12. The system of claim 11, wherein the training dataset is continuously updated based on changes to the distribution chain, wherein the machine learning model is iteratively trained using the training dataset at a plurality of times.

13. The system of claim 12, wherein the changes to the distribution chain include at least one of: changes in components of the distribution chain, and changes to connections between the components of the distribution chain.

14. The system of claim 11, wherein the machine learning model is further trained to optimize a consignment period of the proposed consignment allocation.

15. The system of claim 11, wherein the proposed consignment allocation is at least partially influenced by a predetermined scoring tier of each consignee of the plurality of consignees.

16. The system of claim 11, wherein the system is further configured to:
determine that the proposed consignment allocation can be guaranteed based on consignment data of the plurality of consignees.

17. The system of claim 16, wherein the system is further configured to:
determine whether the at least one first consignee of the plurality of consignees has consumed a consignment within a predetermined period of time.

18. The system of claim 17, wherein the system is further configured to:
generate an electronic notice of demand to each consignee of the plurality of consignees who has not consumed a consignment within a predetermined period of time.

19. The system of claim 11, wherein the system is further configured to:
determine a permissible rollover of consignment goods.
